(19) United States
(12) Patent Application Publication
(10) Pub. No.: US 2015/0206218 A1
(43) Pub. Date: Jul. 23, 2015

(54) Augmented Reality Based Mobile App for Home Buyers

(71) Applicant: Bank of America Corporation, Charlotte, NC (US)

(72) Inventors: Nirmalya Banerjee, Charlotte, NC (US); Hood Qaim-Magami, Montclair, NJ (US); Salil Kumar Jain, Long Island City, NY (US); Bridget Elizabeth O'Connor, Holmdel, NJ (US)

(73) Assignee: Bank of America Corporation, Charlotte, NC (US)

(21) Appl. No.: 14/160,059

(22) Filed: Jan. 21, 2014

(51) Int. Cl. G06Q 30/06; G06T 7/00; G06K 9/00; G06Q 50/16

(52) U.S. Cl. CPC G06Q 30/0623; G06Q 50/16; G06T 7/0042; G06K 9/00671; G06T 2207/10004

(57) ABSTRACT

According to some embodiments, an apparatus comprises a camera, one or more processors, and a display. The camera is pointed at a real estate property. The one or more processors determine information associated with the real estate property. Determining the information comprises, determining a camera position based on a longitude, a latitude, and an orientation of the camera, applying a correction factor to the camera position to yield an approximate longitude and an approximate latitude of the real estate property, determining an address of the real estate property based on the approximate longitude and the approximate latitude, and retrieving the information associated with the real estate property based on the address. The display displays at least a portion of the information associated with the real estate property.

### TECHNICAL FIELD OF THE INVENTION

This invention relates generally to mobile applications for home buyers, and more particularly to augmented reality based mobile applications for home buyers.

### BACKGROUND

Home buying typically involves significant investigative steps on the part of a potential home buyer. The buyer may browse listings on the internet or in printed publications such as newspapers and real estate magazines to find properties the buyer is interested in. The buyer may rely on advertisements to determine which properties are for sale. The buyer may also contact a real estate agent to be shown properties that may be of interest to the buyer.

### SUMMARY

According to some embodiments, an apparatus comprises a camera, one or more processors, and a display. The camera is pointed at a real estate property. The one or more processors determine information associated with the real estate property. Determining the information comprises, determining a camera position based on a longitude, a latitude, and an orientation of the camera, applying a correction factor to the camera position to yield an approximate longitude and an approximate latitude of the real estate property, determining an address of the real estate property based on the approximate longitude and the approximate latitude, and retrieving the information associated with the real estate property based on the address. The display displays at least a portion of the information associated with the real estate property.

Certain embodiments of the invention may provide one or more technical advantages. A technical advantage of one embodiment includes providing a user with the address of a property by pointing a camera at the property. Providing the address of a property by pointing a camera at the property allows a user to quickly determine the address of a property of interest. Another technical advantage of one embodiment includes providing a user with information associated with a property by pointing a camera at the property. Providing information associated with a property by pointing a camera at the property allows a user to quickly see additional information that may of interest to a user interested in purchasing the property.

Certain embodiments of the present disclosure may include some, all, or none of the above advantages. One or more other technical advantages may be readily apparent to those skilled in the art from the figures, descriptions, and claims included herein.

### BRIEF DESCRIPTION OF THE DRAWINGS

To provide a more complete understanding of the present invention and the features and advantages thereof, reference is made to the following description taken in conjunction with the accompanying drawings, in which:

FIG. 1 illustrates an example of a system for an augmented reality based mobile application for home buyers;

FIG. 2 illustrates additional details of a client for using an augmented reality based mobile application for home buyers;

FIGS. 3A and 3B illustrate an example of a potential home buyer viewing properties using an augmented reality based mobile application for home buyers;

FIG. 4 illustrates an example of a display screen for an augmented reality based mobile application for home buyers when viewing a single property;

FIG. 5 illustrates an example of a display screen for an augmented reality based mobile application for home buyers when viewing multiple properties;

FIG. 6 illustrates an example of a map screen that an augmented reality application communicates to a user; and

FIG. 7 illustrates an example flowchart for displaying an augmented reality based view of property.

### DETAILED DESCRIPTION OF THE DRAWINGS

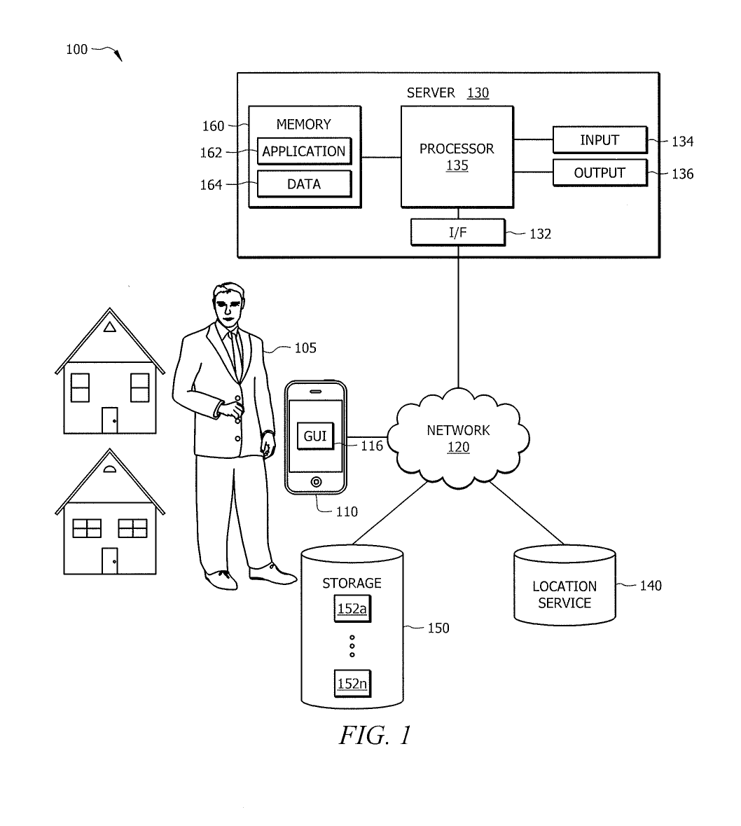

Embodiments of the present invention and its advantages are best understood by referring to FIGS. 1 through 7 of the drawings, like numerals being used for like and corresponding parts of the various drawings.

Home buying typically involves significant investigative steps on the part of a potential home buyer. The buyer may browse listings on the internet or in printed publications such as newspapers and real estate magazines to find properties the buyer is interested in. The buyer may also contact a real estate agent to be shown properties that may be of interest to the buyer. If a buyer is out and sees a property that interests the buyer it may be difficult for the buyer to obtain information about the property quickly. Accordingly an augmented reality based mobile application for home buyers may allow a buyer to quickly obtain information about a property the buyer sees.

FIGS. 1 through 7 below illustrate a system and method for an augmented reality based mobile application for home buyers. For purposes of example and illustration, FIGS. 1 through 7 are described with respect to shopping for a home. However, the present disclosure contemplates facilitating an augmented reality based mobile application for any suitable property, including a real estate property, such as a home (e.g., single-family house, duplex, apartment, condominium, etc.), a commercial property, an industrial property, a multi-unit property, etc.

FIG. 1 illustrates an example of a system 100 for an augmented reality based mobile application for home buyers. System 100 may include one or more users 105, one or more clients 110, a location service 140, a network storage 150, and one or more servers 130. Clients 110, location service 140, network storage 150, and servers 130 may be communicatively coupled by network 120.

In some embodiments, user 105 may be interested in viewing information about properties that user 105 is interested in purchasing. For example, user 105 may wish to view information about a property that user 105 can see. To view information about the property, user 105 may use client 110. Client 110 may refer to a device configured with an augmented reality application that allows user 105 to interact with servers 130, location service 140, and or network storage 150 to view information relevant to property buying.

In some embodiments, client 110 may include a computer, smartphone, smart watch, augmented reality device such as Google Glass™, internet browser, electronic notebook, Personal Digital Assistant (PDA), tablet computer, laptop computer, or any other suitable device, component, or element capable of receiving, processing, storing, and/or communicating information with other components of system 100. Client 110 may also comprise any suitable user interface such as a display, camera, keyboard, or any other appropriate terminal equipment usable by a user 105. It will be understood that system 100 may comprise any number and combination of clients 110.

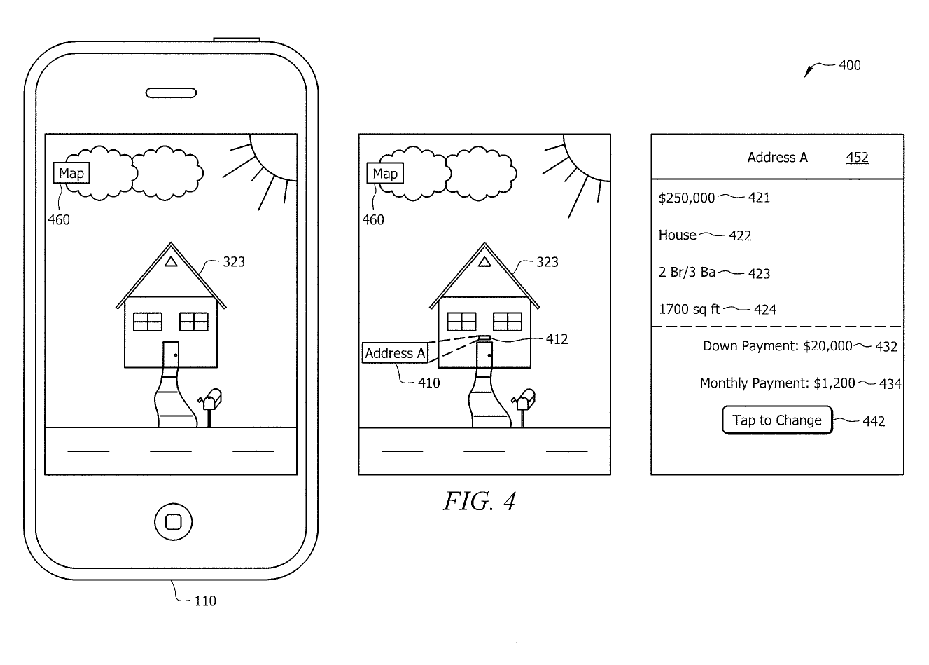

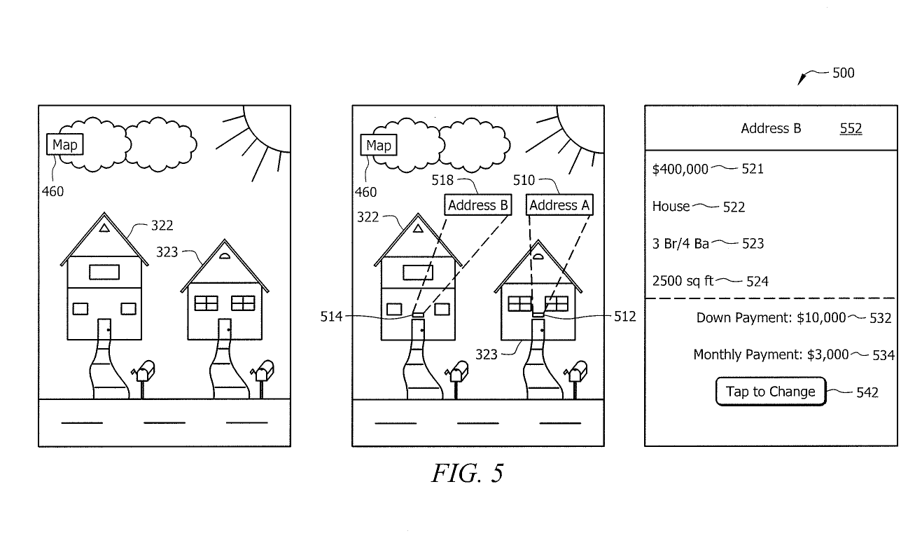

In some embodiments, client 110 may include a graphical user interface (GUI) 116. GUI 116 is generally operable to tailor and filter data entered by and presented to user 105. GUI 116 may provide user 105 with an efficient and user-friendly presentation of information related to property buying presented by an augmented reality application. GUI 116 may comprise a plurality of displays having interactive fields, pull-down lists, and buttons operated by user 105. GUI 116 may be operable to display data received from server 130, location service 140, or network storage 150. GUI 116 may include multiple levels of abstraction including groupings and boundaries. It should be understood that the term GUI 116 may be used in the singular or in the plural to describe one or more GUIs 116 and each of the displays of a particular GUI 116. An example of a display screen that may be displayed by GUI 116 is described with respect to FIGS. 4 and 5 below.

In some embodiments, network storage 150 may refer to any suitable device communicatively coupled to network 120 and capable of storing and facilitating retrieval of data and/or instructions. Examples of network storage 150 include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or or any other volatile or non-volatile, non-transitory computer-readable memory devices that store one or more files, lists, tables, or other arrangements of information. Network storage 150 may store any data and/or instructions utilized by server 130. In particular embodiments, network storage may store information associated with a real estate listing service such as a Multiple Listing Service (MLS) information. In the illustrated embodiment, network storage 150 stores property data 152a to 152n. In some embodiments, property data 152a to 152n may refer to data associated with an address of a property that user 105 is viewing, such as MLS listings. For example, property data 152a to 152n may include floor plans, layouts, property size, property type, and price information associated with an address. Property data 152a to 152n may also include data regarding whether a property is for sale. Client 110 may use property data 152a to 152n to display information about a property to user 105.

In certain embodiments, network 120 may refer to any interconnecting system capable of transmitting audio, video, signals, data, messages, or any combination of the preceding. Network 120 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

Server 130 may refer to any suitable combination of hardware and/or software implemented in one or more modules to process data and provide the described functions and operations. In some embodiments, the functions and operations described herein may be performed by a pool of servers 130. In some embodiments, server 130 may include, for example, a mainframe, server, host computer, workstation, web server, file server, cloud computing cluster, a personal computer such as a laptop, or any other suitable device operable to process data. In some embodiments, server 130 may execute any suitable operating system such as IBM's zSeries/Operating System (z/OS), MS-DOS, PC-DOS, MAC-OS, WINDOWS, UNIX, OpenVMS, or any other appropriate operating systems, including future operating systems. In some embodiments, servers 130 may include a processor 135, server memory 160, an interface 132, an input 134, and an output 136. Server memory 160 may refer to any suitable device capable of storing and facilitating retrieval of data and/or instructions. Examples of server memory 160 include computer memory (for example, RAM or ROM), mass storage media (for example, a hard disk), removable storage media (for example, a CD or a DVD), database and/or network storage (for example, a server), and/or or any other volatile or non-volatile, non-transitory computer-readable memory devices that store one or more files, lists, tables, or other arrangements of information. Although FIG. 1 illustrates server memory 160 as internal to server 130, it should be understood that server memory 160 may be internal or external to server 130, depending on particular implementations. Also, server memory 160 may be separate from or integral to other memory devices to achieve any suitable arrangement of memory devices for use in system 100.

Server memory 160 is generally operable to store an application 162 and data 164. Application 162 generally refers to logic, rules, algorithms, code, tables, and/or other suitable instructions for performing the described functions and operations. In some embodiments, application 162 facilitates determining information provide to client 110. For example, application 162 may interact with client 110, location service 140, and/or network storage 150 to determine a real estate property that user 105 views through a camera of client 110 and to provide information about the real estate property to client 110. Data 164 may include data associated with user 105 such as a password for accessing an application, buyer preferences, account information, credit information, and/or account balances and so on, as well as information associated with properties such as floor plans, layouts, property size, property type, price information, and data regarding whether a property is for sale.

Server memory 160 communicatively couples to processor 135. Processor 135 is generally operable to execute application 162 stored in server memory 160 according to the disclosure. Processor 135 may comprise any suitable combination of hardware and software implemented in one or more modules to execute instructions and manipulate data to perform the described functions for servers 130. In some embodiments, processor 135 may include, for example, one or more computers, one or more central processing units (CPUs), one or more microprocessors, one or more applications, and/or other logic.

In some embodiments, communication interface 132 (I/F) is communicatively coupled to processor 135 and may refer to any suitable device operable to receive input for server 130, send output from server 130, perform suitable processing of the input or output or both, communicate to other devices, or any combination of the preceding. Communication interface 132 may include appropriate hardware (e.g., modem, network interface card, etc.) and software, including protocol conversion and data processing capabilities, to communicate through network 120 or other communication system, which allows server 130 to communicate to other devices. Communication interface 132 may include any suitable software operable to access data from various devices such as clients 110, network storage 150, and/or location service 140. Communication interface 132 may also include any suitable software operable to transmit data to various devices such as clients 110 and/or location service 140. Communication interface 132 may include one or more ports, conversion software, or both. In general, communication interface 132 receives and transmits information from clients 110, network storage 150, and/or location service 140.

In some embodiments, input device 134 may refer to any suitable device operable to input, select, and/or manipulate various data and information. Input device 134 may include, for example, a keyboard, mouse, graphics tablet, joystick, light pen, microphone, scanner, or other suitable input device. Output device 136 may refer to any suitable device operable for displaying information to a user. Output device 136 may include, for example, a video display, a printer, a plotter, or other suitable output device.

In certain embodiments location service 140 may refer to a service that stores addresses of properties associated with or near certain latitudes and longitudes. Location service 140 may communicate an address or addresses to client 110 when provided with a latitude and longitude by client 110. Location service 140 may communicate addresses to client 110 within a certain distance of a latitude and longitude provided by client 110. In particular embodiments, location service 140 may be a cloud based service.

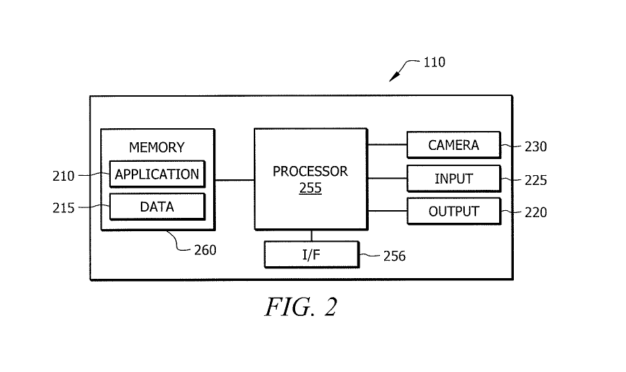

FIG. 2 illustrates additional details of client 110. In some embodiments, client 110 may include a processor 255, client memory 260, an interface 256, an input 225, a camera 230, and an output 220. Client memory 260 may refer to any suitable device capable of storing and facilitating retrieval of data and/or instructions. Examples of client memory 260 include computer memory (for example, RAM or ROM), mass storage media (for example, a hard disk), removable storage media (for example, a CD or a DVD), database and/or network storage (for example, a server), and/or or any other volatile or non-volatile, non-transitory computer-readable memory devices that store one or more files, lists, tables, or other arrangements of information. Although FIG. 2 illustrates client memory 260 as internal to client 110, it should be understood that client memory 260 may be internal or external to client 110, depending on particular implementations.

Client memory 260 is generally operable to store an augmented reality application 210 and user data 215. Augmented reality application 210 generally refers to logic, rules, algorithms, code, tables, and/or other suitable instructions for performing the described functions and operations. User data 215 may include data associated with user 105 such as a password for accessing an application, the location of client 110, buyer preferences, and/or account information and so on.

In some embodiments, augmented reality application 210, when executed by processor 255, facilitates determining the location of a property being viewed by user 105 through client 110. For example, user 105 may point camera 230 toward a property to view the property on the screen of client 110. Augmented reality application 210 may determine a position of camera 230. The position of camera 230 may include a latitude and longitude as well as an orientation of the direction in which camera 230 is pointed. Augmented reality application 210 may determine a location of the property using the position of camera 230 and a correction factor. In certain embodiments, augmented reality application 210 may determine the location of the property as an approximate latitude and approximate longitude. Augmented reality application 210 may provide the location to location service 140, and location service 140 may return an address for the property that user 105 is viewing. Augmented reality application 210 may use the address to obtain property data 152 associated with the address. In certain embodiments, augmented reality application 210 may provide the address to server 130. Server 130 may use the address to retrieve property data 152 associated with the address from network storage 150 and return property data 152 to augmented reality application 210. Alternatively, augmented reality application 210 may provide the address to network storage 150 and receive property data 152 associated with the address from network storage 150. Augmented reality application 210 may provide property data 152 to server 130 and receive property buying information such as mortgage rates and monthly payments in response. In some embodiments, augmented reality application 210 may be operable to allow a user to look up a property by displaying a list of properties near the location of client 110 or by receiving an address or zip code input from user 105.

Client memory 260 communicatively couples to processor 255. Processor 255 is generally operable to execute augmented reality application 210 stored in client memory 260 according to the disclosure. Processor 255 may comprise any suitable combination of hardware and software implemented in one or more modules to execute instructions and manipulate data to perform the described functions for clients 110. In some embodiments, processor 255 may include, for example, one or more computers, one or more central processing units (CPUs), one or more microprocessors, one or more applications, and/or other logic.

In some embodiments, communication interface 256 (I/F) is communicatively coupled to processor 255 and may refer to any suitable device operable to receive input for client 110, send output from client 110, perform suitable processing of the input or output or both, communicate to other devices, or any combination of the preceding. Communication interface 256 may include appropriate hardware (e.g., modem, network interface card, etc.) and software, including protocol conversion and data processing capabilities, to communicate through network 120 or other communication system, which allows client 110 to communicate to other devices. Communication interface 256 may include any suitable software operable to access data from various devices such as servers 130, network storage 150 and/or location service 140. Communication interface 256 may also include any suitable software operable to transmit data to various devices such as servers 130 and/or location service 140. Communication interface 256 may include one or more ports, conversion software, or both.

In some embodiments, input device 225 may refer to any suitable device operable to input, select, and/or manipulate various data and information. Input device 225 may include, for example, a keyboard, mouse, graphics tablet, joystick, light pen, microphone, scanner, touch screen, global positioning system (GPS) sensor, gyroscope, compass, magnetometer, camera 230, or other suitable input device. Output device 220 may refer to any suitable device operable for displaying information to a user. Output device 220 may include, for example, a video display, a printer, a plotter, or other suitable output device.

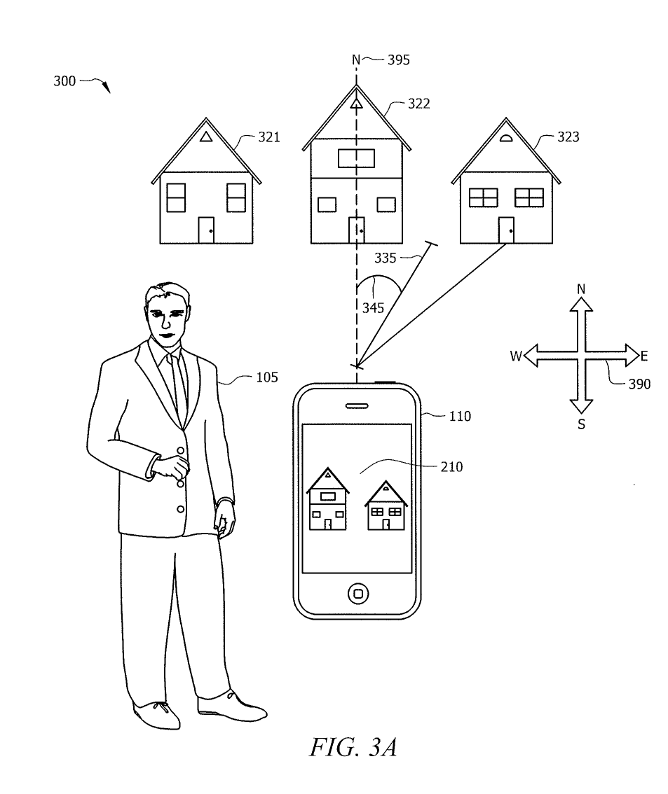

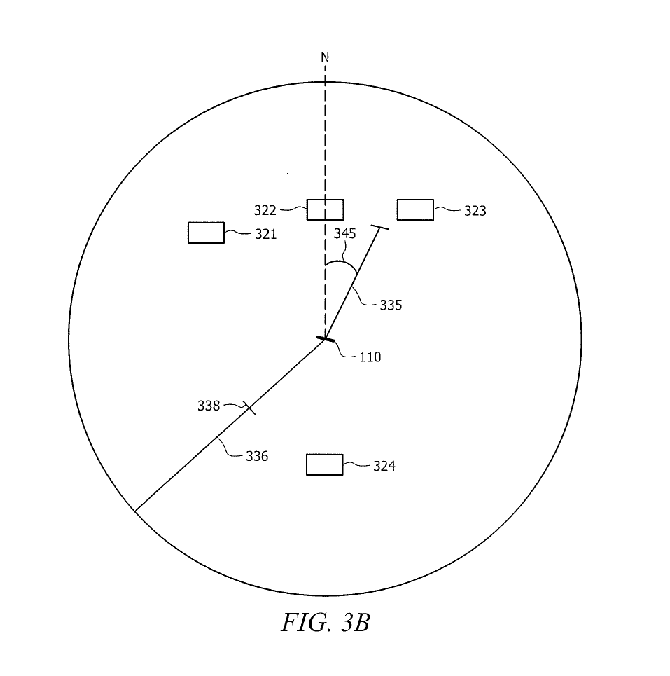

FIG. 3A illustrates an example of user 105 (a potential property buyer) viewing properties using augmented reality application 210. User 105 may be interested in particular properties. In the illustrated example, user 105 may point camera 230 of client 110 at property 322 and property 323. Augmented reality application 210 executing on client 110 may display an image of property 322 and property 323 captured by camera 230 on the screen of client 110. Augmented reality application 210 may display the image of property 322 and property 323 in real time, allowing user 105 to view different properties conveniently.

Augmented reality application 210 may determine a position of client 110 by determining the latitude and longitude of client 110 and an orientation of client 110. In some embodiments, augmented reality application 210 may use GPS or wireless signal triangulation to determine the latitude and longitude of client 110. Augmented reality application 210 may also determine an orientation of client 110. The orientation may include both a vertical orientation and a horizontal orientation. Augmented reality application 210 may determine the vertical orientation of client 110 using a gyroscope of client 110. The vertical orientation may comprise an angle which camera 230 is pointed up or down from the vertical plane. For example, if the user is pointing camera 230 of client 110 at the sky, then augmented reality application 210 may determine the angle at which camera 230 is pointed up from the horizon. Likewise, if the user is pointing camera 230 of client 110 at the ground, then augmented reality application 210 may determine the angle at which camera 230 is pointed down from the horizon. In certain embodiments, if the vertical orientation exceeds a certain angle, augmented reality application 210 may determine that camera 230 is not pointed at a property, and display a message on client 110 to notify user 105 that the camera 230 is not pointed at a property. As an example, augmented reality application 210 may determine that camera 230 is not pointed at a property if the vertical orientation exceeds thirty degrees in the upward or downward direction (where zero degrees corresponds to a vertical orientation parallel to the earth's surface).

The horizontal orientation may comprise an angle 345. Augmented reality application 210 may determine the horizontal orientation of client 110 using a compass or magnetometer of client 110. Angle 345 may be an angle that camera 230 is rotated away from a reference direction 395, in particular embodiments. In the illustrated example, reference direction 395 is North, but reference direction 395 may be any direction in other embodiments. Angle 345 may be the angle that the center of camera 230's view is rotated from reference direction 395. In the illustrated example, camera 230 is pointed between property 322 and property 323. As a result, augmented reality application 210 determines angle 345 to be the angle from reference direction 395 to a point between property 322 and property 323.

If camera 230 is pointed at a property, augmented reality application 210 may determine the location of the property. In the illustrated embodiment, user 105 has pointed camera 230 towards property 322 and property 323. Augmented reality application 210 may determine the location of property 322 and property 323. The location of property 322 and property 323 may be a latitude and longitude of property 322 and property 323. In certain embodiments, augmented reality application 210 may determine an approximate latitude and longitude for multiple properties. For example, augmented reality application 210 may determine the approximate latitude and longitude of a point between property 322 and property 323.

Augmented reality application 210 may determine the approximate latitude and approximate longitude of property 322 and 323 using the position of client 110, angle 345, and a correction factor 335. Correction factor 335 may approximate a viewing distance indicating how far user 105 is likely to be from property 322 and 323 when viewing the properties through camera 230. In certain embodiments, correction factor 335 may be a pre-determined viewing distance that is between 1 and 1000 meters. For example, correction factor 335 may be 15 meters. In particular embodiments, augmented reality application 210 may adjust the pre-determined viewing distance of correction factor 335 based on the position of client 110. For example, augmented reality application 210 may use a shorter pre-determined viewing distance, such as 10 meters, if client 110 is in a densely populated urban area and a longer pre-determined viewing distance, such as 25 meters, if client 110 is an a sparsely populated rural area. Additionally, augmented reality application 210 may be able to use different pre-determined viewing distances for specific cities or locations. For example, augmented reality application 210 may use a different pre-determined viewing distance for each of New York City, Indianapolis, and Boise.

Augmented reality application 210 may also dynamically determine correction factor 335, in some embodiments. For example, augmented reality application 210 may be able to use a range finder feature of camera 230 to determine a distance from client 110 to property 322 and property 323 and use this distance as correction factor 335. As another example, augmented reality application 210 may dynamically determine correction factor 335 based on the scale of the real estate property displayed on the screen (e.g., a larger scale indicates user 105 is closer to the property and correction factor 335 should be smaller).

In certain embodiments, augmented reality application 210 may use the following formula to determine the latitude and longitude of a property, using client 110's latitude and longitude, angle 345 and correction factor 335.

$${Lat}_{2} = arc sin ( sin ( {Lat}_{1} ) * cos ( \frac{d}{R} ) + cos ( {Lat}_{2} ) * sin ( \frac{d}{R} ) * cos ( θ ) )$$

$${Long}_{2} = {Long}_{1} + arc tan ( sin ( θ ) * sin ( \frac{d}{R} ) * cos ( {Lat}_{1} ) , cos ( \frac{d}{R} ) - sin ( {Lat}_{1} ) * sin ( {Lat}_{2} ) )$$

Where Lat₁ represents the latitude of client 110, Lat₂ represents the latitude of the property, Long₁ represents the longitude of client 110, Long₂ represents the longitude of the property, d represents the distance between client 110 and the property, θ represents the angle measured in radians, clockwise from north, in which camera 230 is pointed, and R represents the radius of the Earth. As applied to the illustrated embodiment, angle 345 would be represented by θ and correction factor 335 would be represented by d in the above equation. Thus, correction factor 335 may be applied in a direction based on the orientation of camera 230.

Although this example applies correction factor 335 relative to the horizontal orientation of camera 230, correction factor 335 could also be applied relative to the vertical orientation of camera 230. For example, if camera 230 is pointed slightly upward, augmented reality application 210 may determine that user 105 wishes to view a taller building in the background rather than (or in addition to) a shorter building in the foreground.

After determining the approximate latitude and approximate longitude of the property user 105 is viewing, augmented reality application 210 may use the approximate latitude and approximate longitude to determine an address of the property user 105 is viewing. Augmented reality application 210 may determine the address of the property by communicating the approximate latitude and approximate longitude to location service 140. In return, location service may provide an address or addresses close to the approximate latitude and approximate longitude determined by augmented reality application 210. For example, in the illustrated embodiment, user 105 is viewing property 322 and property 323, augmented reality application 210 may communicate the approximate latitude and approximate longitude of a point between property 322 and property 323 to location service 140, and location service 140 may return the addresses of both property 322 and property 323. Similarly, if user 105 is viewing a property containing multiple housing units, such as an apartment, condominium, or duplex, location service 140 may return the addresses of some or all of the housing units associated with the property. In certain embodiments, augmented reality application 210 may determine the address by retrieving additional information as described below to determine the nearest address to the approximate latitude and approximate longitude that corresponds to a property that is for sale.

Augmented reality application 210 may prompt user 105 to confirm the address user 105 is interested in before retrieving information about the property associated with the address returned by location service 140. In particular embodiments, augmented reality application 210 may prompt user 105 to choose an address that user 105 is interested in if location service 140 returned more than one address. For example, in the illustrated embodiment, augmented reality application 210 may prompt user 105 to choose the address associated with property 322 or the address associated with property 323.

Augmented reality application 210 may use the address information from location service 140 to obtain information about the property user 105 is viewing. Augmented reality application 210 may obtain information about the property user 105 is viewing from server 130 or network storage 150. In particular embodiments, information retrieved by may comprise information included in MLS listings stored in property data 152a through 152n by network storage 150, such as a floor plan, a property layout, property size, property type, price information, and whether the property is for sale.

Augmented reality application 210 may additionally display to user 105 additional information associated with purchasing the property user 105 is viewing. For example, augmented reality application 210 may display a mortgage calculator which displays an estimated monthly payment based on the price of the property and a down payment entered by user 105. In a particular embodiment, Augmented reality application 210 may retrieve current mortgage rates from server 130 to provide up-to-date mortgage information. Augmented reality application 210 may also allow user 105 to contact a real estate agent to enable user 105 to obtain more information about the property user 105 is viewing. Augmented reality application 210 may further allow user 105 to apply for a loan to allow user 105 to determine if user 105 may be able to purchase the property being viewed by user 105.

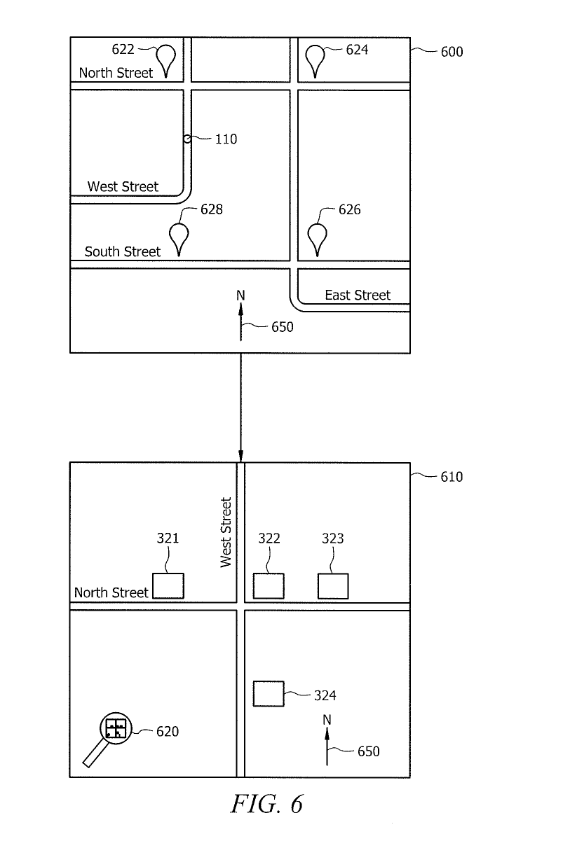

FIG. 3B illustrates, from an overhead perspective, an example of user 105 viewing properties using augmented reality application 210. Augmented reality application 210 may determine the addresses of all properties within a radius 336 of client 110 by providing the location of client 110 to location service 140 and requesting addresses for all properties within radius 336. After receiving the addresses of all properties within radius 336, augmented reality application 210 may display the addresses of those properties being viewed by user 105 on client 110, as described with respect to FIGS. 4 and 5, or display a map showing the locations of the properties, as described with respect to FIG. 6. By retrieving addresses with in radius 336, augmented reality application 210 may be able to seamlessly display addresses overlaid onto an image of a property as user 105 rotates client 110 to face different properties or moves within radius 336.

Radius 336 may by equal to correction factor 335, in certain embodiments. In other embodiments, radius 336 may vary as a function of correction factor 335. For example, radius 336 may be twice the distance of correction factor 335. In yet other embodiments, radius 336 may be determined independently from correction factor 335. For example, radius 336 may be pre-configured to a static value, such as 500 meters, or radius 336 may be dynamically determined in a similar manner to that described for correction factor 335.

When client 110 moves more than a distance 338, augmented reality application 210 may update the addresses with radius 336, by making a request to location service 140. Distance 338 may by equal to correction factor 335 or radius 336, in certain embodiments. In other embodiments, distance 338 may vary as a function of correction factor 335 or radius 336. In yet other embodiments, distance 338 may be determined independently from correction factor 335 or radius 336. For example, distance 338 may be pre-configured to a static value, such as 500 meters, or may be dynamically determined.

FIG. 4 illustrates an example of a display screen 400 that augmented reality application 210 installed on client 110 communicates to user 105 when user 105 is viewing a single property using augmented reality application 210. In the illustrated example, user 105 is viewing property 323 using camera 230. Augmented reality application 210 may depict an image of property 323 and an area that surrounds property 323. Augmented reality application 210 may display the image of property 323 and the surrounding area in real time on client 110. Augmented reality application 210 may determine the address of property 323 as described above with respect to FIG. 3. In certain embodiments, augmented reality application 210 may display address information over the image of property 323 and the area that surrounds property 323. Augmented reality application 210 may display the address information positioned proximate to property 323. For example, in the illustrated embodiment, augmented reality application 210 displays address box 410 overlaid onto the image containing property 323 and proximate to property 323. Address box 410 may display the address of property 323. Address box 410 may also display additional information about property 323, such as a floor plan layout, property size, property type, and price information, in certain embodiments.

Augmented reality application 210 may also display icon 412 directly overlaid onto the image of property 323. Icon 412 may serve to alert user 105 that address box 410 is associated with property 323. In certain embodiments, augmented reality application 210 may display icon 412 and address box 410 connected by a graphical feature such as a line or dashed line. Augmented reality application 210 may also display map icon 460. User 105 may select map icon 460 to cause augmented reality application 210 to display map screen 600.

User 105 may select address box 410 or icon 412 if user 105 wishes to view additional information about property 323. User 105 may select address box 410 or icon 412 by touching or clicking on address box 410 or icon 412 on the screen of client 110. If user 105 selects address box 410 or icon 412, augmented reality application 210 may display information screen 452. Information screen 452 displays information about property 323 that augmented reality application 210 obtains from server 130 or network storage 150 as described above with respect to FIGS. 1 and 3. In particular embodiments, augmented reality application 210 may allow user 105 to save a property as a favorite. Augmented reality application 210 may save a picture of the property and information about the property on client 110, server 130, or network storage 150. User 105 may use augmented reality application 210 to view properties saved as favorites at any time after user 105 has saved the property as a favorite.

In the illustrated embodiment information screen 452 displays property price 421, property type 422, property layout 423, property size 424, down payment 432, monthly payment 434, and tap to change button 442. Information screen 452 may also display an indication to user 105 of whether property 323 is for sale. Property price 421 indicates the value of property 323, “$250,000.” Property type 422 indicates that property 323 is a house. Property type 422 may indicate that a property is an apartment, condominium, co-op, or the like for other types of property. Property layout 423 indicates that property 323 has a 2 bedroom, 3 bathroom layout. Property size 424 indicates that property 323 is a 1700 square foot property. In particular embodiments, information screen 452 may enable user 105 to view a full floor plan of property 323, for example, by receiving a selection of property layout 423 or property size 424 from user 105.

Down payment 432 may indicate an amount of a down payment that user 105 intends to make. Monthly payment 434 may display the monthly payment of a mortgage based on the amount of down payment indicated by down payment 432. In certain embodiments, monthly payment 434 may be based on additional factors such as a loan term an interest rate. Augmented reality application 210 may store a set of preferences for user 105 that includes a down payment amount, loan term, and interest rate. Alternatively, augmented reality application 210 may obtain information about user 105 that includes a down payment amount, loan term, and interest rate from server 130. In certain embodiments, server 130 may determine an interest rate based on information associated with user 105 stored on server 130, such as a credit score. User 105 may change the factors that monthly payment 434 is based on by selecting tap to change button 442. For example, user 105 may select tap to change button 442 and input different down payment, loan term, and interest rate information. Changing factors on which monthly payment 434 is based may cause monthly payment 434 to change.

In certain embodiments, information screen 452 may not display down payment 432 or tap to change button 442. For example, if property 323 were an apartment or other property available for rent, information screen 452 may display monthly payment 434 showing the monthly rent.

Information screen 452 may display additional features in certain embodiments. Information screen 452 may display an icon that enables user 105 to use augmented reality application 210 to contact a real estate agent, apply for a loan, or display an affordability calculator based on information retrieved by augmented reality application 210 from server 130. In certain embodiments information screen 452 may accept input from user 105, such as a swipe or touch on a particular part of the screen, to cause augmented reality application 210 to return to displaying an image of property 323. For example, after viewing information associated with property 323, user 105 may wish to view both property 322 and 323 using augmented reality application 210.

FIG. 5 illustrates an example of a display screen 500 that augmented reality application 210 installed on client 110 communicates to user 105 when user 105 is viewing more than one property using augmented reality application 210. In the illustrated example, user 105 is viewing property 322 and property 323 using camera 230. Augmented reality application 210 may display an image of property 322 and property 323 in real time on client 110. Augmented reality application 210 may determine the addresses of property 322 and property 323 as described above with respect to FIG. 3.

Augmented reality application 210 may display a first indicator indicating the availability information associated with a first property and a second indicator indicating the availability of information associated with a second property. For example, in the illustrated embodiment, augmented reality application 210 displays icon 512 indicating that information associated with property 323 is available and icon 514 indicating that information associated with property 322 is available. Augmented reality application may display address box 510 and address box 518 overlaid onto the image containing property 322 and property 323. Address box 510 may display the address of property 323, and Address box 518 may display the address of property 322. Address boxes 510 and 518 may also display additional information about property 323 and property 322, such as a floor plan layout, property size, property type, and price information, in certain embodiments.

Augmented reality application 210 may also display icon 512 directly overlaid onto the image of property 323 and icon 514 directly overlaid onto the image of property 322. Icon 514 may serve to alert user 105 that address box 518 is associated with property 322, and icon 512 may serve to alert user 105 that address box 510 is associated with property 323. In certain embodiments augmented reality application 210 may display icon 512 and address box 510 connected by a graphical feature such as a line or dashed line and icon 514 and address box 518 connected by a graphical feature such as a line or dashed line. Augmented reality application 210 may also display map icon 460. User 105 may select map icon 460 to cause augmented reality application 210 to display map screen 600.

User 105 may select address box 510 or icon 512 if user 105 wishes to view additional information about property 323. Likewise, user 105 may select address box 518 or icon 514 if user 105 wishes to view additional information about property 322. In a similar manner as described above with respect to FIG. 4, user 105 may select address box 510, address box 518, icon 512, or icon 514 by touching or clicking the respective address box or icon on the screen of client 110. As described above with respect to FIG. 4, user 105 may select an address box or icon associated with property 322 or 323, to cause augmented reality application 210 to display an information screen containing information about the selected property. In particular embodiments, augmented reality application 210 may allow user 105 to save a property as a favorite. Augmented reality application 210 may save a picture of the property and information about the property on client 110, server 130, or network storage 150. User 105 may use augmented reality application 210 to view properties saved as favorites at any time after user 105 has saved the property as a favorite.

In the illustrated embodiment user 105 has selected to view information associated with property 322, causing augmented reality application 210 to display information screen 552. Information screen 552 displays similar information about property 322 as information screen 452 of FIG. 4 displays about property 323. Augmented reality application 210 may obtain the information displayed in information screen 552 from server 130 or network storage 150 as described above with respect to FIGS. 1 and 3. In the illustrated embodiment information screen 552 displays property price 521, property type 522, property layout 523, property size 524, down payment 532, monthly payment 534, and tap to change button 542. Information screen 552 also may display an indication to user 105 of whether property 322 is for sale.

Property price 521 indicates the value of property 322, “$400,000.” Property type 522 indicates that property 323 is a house. Property layout 523 indicates that property 322 has a 3 bedroom, 4 bathroom layout. Property size 524 indicates that property 322 is a 2500 square foot property. In particular embodiments, information screen 552 may enable user 105 to view a full floor plan of property 322, for example, by receiving a selection of property layout 523 or property size 524 from user 105.

Down payment 532 may indicate an amount of a down payment that user 105 intends to make. Monthly payment 534 may display the monthly payment of a mortgage based on the amount of down payment indicated by down payment 532. In certain embodiments, monthly payment 534 may be based on additional factors such as a loan term an interest rate. Augmented reality application 210 may store a set of preferences for user 105 that includes a down payment amount, loan term, and interest rate. Alternatively, augmented reality application 210 may obtain information about user 105 that includes a down payment amount, loan term, and interest rate from server 130. In certain embodiments, server 130 may determine an interest rate based on information associated with user 105 stored on server 130, such as a credit score. User 105 may change the factors that monthly payment 534 is based on by selecting tap to change button 542. For example, user 105 may select tap to change button 542 and input different down payment, loan term, and interest rate information. Changing factors on which monthly payment 534 is based cause monthly payment 534 to change.

In certain embodiments, information screen 552 may not display down payment 532 or tap to change button 542. For example, if property 322 were an apartment or other property available for rent, information screen 552 may display monthly payment 534 showing the monthly rent.

Information screen 552 may display additional features in certain embodiments. Information screen 552 may display an icon that enables user 105 to use augmented reality application 210 to contact a real estate agent, apply for a loan, or display an affordability calculator based on information retrieved by augmented reality application 210 from server 130. In certain embodiments information screen 552 may accept input from user 105, such as a swipe or touch on a particular part of the screen, to cause augmented reality application 210 to return to displaying a real time image of property 322 and property 322.

FIG. 6 illustrates an example of a map screen 600 that augmented reality application 210 communicates to user 105 when user 105 has selected a map view using augmented reality application 210. Map screen 600 may display a road map of the area surrounding user 105. In some embodiments, map screen 600 may display a map within radius 336 of user 105. User 105 may zoom in or out of map screen 600, causing augmented reality application 210 to display a more detailed view covering less area, or less detailed view covering more area, respectively. In certain embodiments, map screen 600 may be centered on user 105 and rotate with user 105 so that the direction user 105 is facing is always at the top of the screen. In such an embodiment, arrow 650 may be configured to always point north. In an alternative embodiment, map screen 600 may be fixed, for example so that the direction north is always at the top of the screen, and arrow 650 may rotate as user 105 rotates to display an indication of the direction user 105 is facing.

Map screen 600 may display locations of nearby properties. Augmented reality application 210 may obtain addresses of these properties from location service 140. Map screen 600 may display the location of properties by displaying markers representing clusters or groups of properties when map screen 600 is displaying a sufficiently zoomed out view of the area surrounding user 105. For example, markers 622, 624, 626, and 628 may reach represent one or more properties. User 105 may select a marker to cause augmented reality application 210 to display a zoomed in view of map screen 600 showing the individual properties represented by the selected marker. For example, user 105 may select marker 622 to cause augmented reality application 210 to display map screen 610 displaying individual properties 321, 322, 323, and 324. User 105 may select an icon representing one of the properties to cause augmented reality application 210 to display information about that property. For example, user 105 may select the icon representing property 323 to cause augmented reality application 210 to display information screen 452. To return to map screen 600 from map screen 610, user 105 may select zoom icon 620.

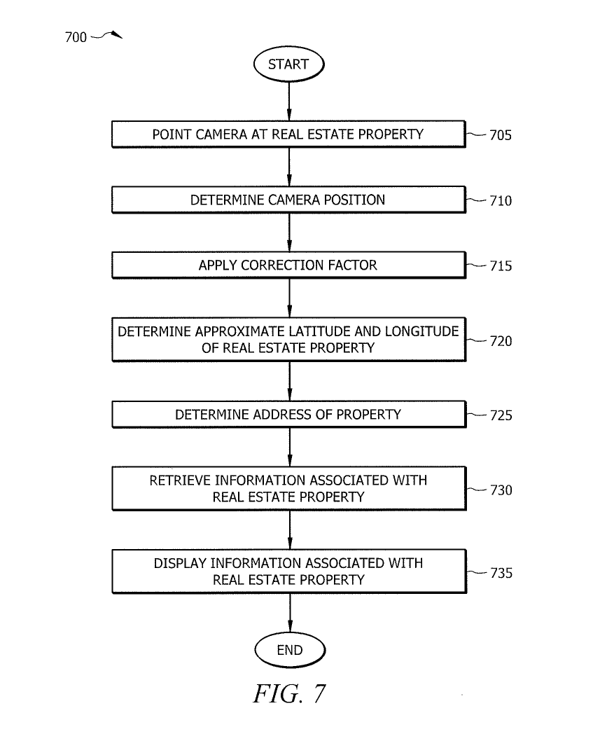

FIG. 7 illustrates an example flowchart 700 for displaying an augmented reality view of property. Method 700 may be carried out by augmented reality application 210 being executed on client 110. The method begins at step 705 where user 105 points camera 230 of client 110 at a property, causing the property to be displayed in real time on the screen of client 110.

At step 710, augmented reality application 210 determines the position of camera 230. As described with respect to FIG. 3A, augmented reality application 210 may determine the position of camera 230 by determining a latitude, longitude, and orientation of camera 230. Augmented reality application 210 may use GPS or wireless signal triangulation to determine the latitude and longitude of client 110. Augmented reality application 210 may determine a horizontal orientation of client 110 using a compass or magnetometer of client 110, and determine a vertical orientation of client 110 using a gyroscope of client 110.

At step 715, augmented reality application 210 applies a correction factor. As described with respect to FIG. 3A, augmented reality application 210 may apply a static pre-determined correction factor, a pre-determined correction factor based on the location of client 110, or a dynamic correction factor based on input from camera 230.

At step 720, augmented reality application 210 determines the approximate latitude and longitude of the property. As described with respect to FIG. 3A, augmented reality application 210 uses the latitude, longitude, and orientation of camera 230, along with the correction factor applied in step 715 to determine the approximate latitude and longitude of the real estate property. If user 105 is viewing multiple properties, augmented reality application 210 may determine a latitude and longitude between the properties, in certain embodiments.

At step 725, augmented reality application 210 determines the address of the property at which camera 230 is pointed. As described with respect to FIGS. 1 and 3A, augmented reality application 210 may determine the address of the properties by communicating the latitude and longitude of the property determined in step 720 to location service 140. Location service 140 then returns an address or addresses of properties that are close to the latitude and longitude determined in step 720. In certain embodiments, augmented reality application 210 may determine the address that corresponds to an on-sale property nearest to the approximate longitude and the approximate latitude. In certain embodiments, as described with respect to FIG. 3B, augmented reality application 210 may determine the addresses of all properties within a radius 336 of client 110. Augmented reality application 210 may display the address or addresses received from location service as illustrated in FIGS. 4 and 5.

At step 730, augmented reality application 210 retrieves information associated with the property using the address determined in step 725. As described with respect to FIGS. 1 and 3, augmented reality application 210 may retrieve information associated with the property by communicating the address determined in step 725 to network storage 150 or server 130. In certain embodiments, if location service 140 returned multiple addresses in step 725, augmented reality application 210 may prompt user 105 to select one address, as illustrated in FIG. 5. Information that augmented reality application 210 retrieves may include a floor plan, layout, property size, property type, and price information associated with the address determined in step 725, as well as whether the property associated with the address determined in step 725 is for sale.

At step 735, augmented reality application 210 displays the information retrieved in step 730. In certain embodiments, augmented reality application 210 may display this information as illustrated in FIGS. 4 and 5. In some embodiments, augmented reality application 210 may save a photograph tagged with any suitable information about the real estate property. The photograph may allow user 105 to review the property information or to link to updated information about the property after user 105 has left the location. The method then ends.

Modifications, additions, or omissions may be made to the systems described herein without departing from the scope of the invention. The components may be integrated or separated. Moreover, the operations may be performed by more, fewer, or other components. Additionally, the operations may be performed using any suitable logic comprising software, hardware, and/or other logic. As used in this document, “each” refers to each member of a set or each member of a subset of a set.

Modifications, additions, or omissions may be made to the methods described herein without departing from the scope of the invention. For example, the steps may be combined, modified, or deleted where appropriate, and additional steps may be added. Additionally, the steps may be performed in any suitable order without departing from the scope of the present disclosure.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. An apparatus comprising:
a camera operable to be pointed at a real estate property;
one or more processors operable to determine information associated with the real estate property, wherein determining the information comprises:
determining a camera position based on a longitude, a latitude, and an orientation of the camera;
applying a correction factor to the camera position to yield an approximate longitude and an approximate latitude of the real estate property;
determining an address of the real estate property based on the approximate longitude and the approximate latitude; and
retrieving the information associated with the real estate property based on the address; and
a display operable to:
display at least a portion of the information associated with the real estate property.

2. The apparatus of claim 1, wherein applying the correction factor comprises:
determining a pre-determined viewing distance selected to approximate a distance between the camera and the real estate property; and
applying the pre-determined viewing distance to the longitude and the latitude of the camera, the pre-determined viewing distance applied in a direction determined based on the orientation of the camera.

3. The apparatus of claim 1, wherein displaying the at least a portion of the information associated with the real estate property comprises:
displaying address information over an image, the image depicting the real estate property and an area that surrounds the real estate property, wherein the address information is positioned proximate to the real estate property within the image.

4. The apparatus of claim 1, wherein:
the one or more processors further operable to:
determine that the approximate longitude and the approximate latitude potentially correspond to the real estate property and a second real estate property; and
the display further operable to:
display a first indicator indicating the availability of the information associated with the real estate property; and
display a second indicator indicating the availability of second information, the second information associated with the second real estate property;
wherein the displaying the at least a portion of the information associated with the real estate property occurs in response to a request corresponding to the first indicator.

5. The apparatus of claim 1, wherein the information associated with the real estate property comprises one or more of price, housing type, floor plan, layout, and square footage.

6. The apparatus of claim 1, wherein:
determining the address comprises determining that the address corresponds to an on-sale property nearest to the approximate longitude and the approximate latitude.

7. A non-transitory computer readable storage medium comprising logic, the logic, when executed by a processor, operable to:
display an image from a camera pointed at a real estate property;
determine information associated with the real estate property, wherein determining the information comprises:
determining a camera position based on a longitude, a latitude, and an orientation of the camera;
applying a correction factor to the camera position to yield an approximate longitude and an approximate latitude of the real estate property;
determining an address of the real estate property based on the approximate longitude and the approximate latitude; and
retrieving the information associated with the real estate property based on the address; and
display at least a portion of the information associated with the real estate property.

8. The logic of claim 7, wherein applying the correction factor comprises:
determining a pre-determined viewing distance selected to approximate a distance between the camera and the real estate property; and
applying the pre-determined viewing distance to the longitude and the latitude of the camera, the pre-determined viewing distance applied in a direction determined based on the orientation of the camera.

9. The logic of claim 7, wherein displaying the at least a portion of the information associated with the real estate property comprises:
displaying address information over an image, the image depicting the real estate property and an area that surrounds the real estate property, wherein the address information is positioned proximate to the real estate property within the image.

10. The logic of claim 7, the logic further operable to:
determine that the approximate longitude and the approximate latitude potentially correspond to the real estate property and a second real estate property;
display a first indicator indicating the availability of the information associated with the real estate property; and
display a second indicator indicating the availability of second information, the second information associated with the second real estate property;
wherein the displaying the at least a portion of the information associated with the real estate property occurs in response to a request corresponding to the first indicator.

11. The logic of claim 7, wherein the information associated with the real estate property comprises one or more of price, housing type, floor plan, layout, and square footage.

12. The logic of claim 7, wherein:
determining the address comprises determining that the address corresponds to an on-sale property nearest to the approximate longitude and the approximate latitude.

13. A method comprising:
displaying an image from a camera pointed at a real estate property;
determining, by a processor, information associated with the real estate property, wherein determining the information comprises:
determining a camera position based on a longitude, a latitude, and an orientation of the camera;
applying a correction factor to the camera position to yield an approximate longitude and an approximate latitude of the real estate property;
determining an address of the real estate property based on the approximate longitude and the approximate latitude; and
retrieving the information associated with the real estate property based on the address; and
displaying at least a portion of the information associated with the real estate property.

14. The method of claim 13, wherein applying the correction factor comprises:
determining a pre-determined viewing distance selected to approximate a distance between the camera and the real estate property; and
applying the pre-determined viewing distance to the longitude and the latitude of the camera, the pre-determined viewing distance applied in a direction determined based on the orientation of the camera.

15. The method of claim 13, wherein displaying the at least a portion of the information associated with the real estate property comprises:
displaying address information over an image, the image depicting the real estate property and an area that surrounds the real estate property, wherein the address information is positioned proximate to the real estate property within the image.

16. The method of claim 13, further comprising:
determining that the approximate longitude and the approximate latitude potentially correspond to the real estate property and a second real estate property;
displaying a first indicator indicating the availability of the information associated with the real estate property; and
displaying a second indicator indicating the availability of second information, the second information associated with the second real estate property;
wherein the displaying the at least a portion of the information associated with the real estate property occurs in response to a request corresponding to the first indicator.

17. The method of claim 13, wherein the information associated with the real estate property comprises one or more of price, housing type, floor plan, layout, and square footage.

18. The method of claim 13, wherein:
determining the address comprises determining that the address corresponds to an on-sale property nearest to the approximate longitude and the approximate latitude.
